(19) United States
(12) Patent Application Publication
(10) Pub. No.: US 2004/0125704 A1
(43) Pub. Date: Jul. 1, 2004

(54) Optical device, optical module, optical head, and optical recording/reproducing apparatus using the same

(75) Inventors: Tsutomu Ishi, Tokyo (JP); Junichi Fujikata, Tokyo (JP); Hitoshi Yokota, Tokyo (JP); Kunio Kato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/623,657

(22) Filed: Jul. 22, 2003

(30) Foreign Application Priority Data
Jul. 29, 2002 (JP) 220338/2002

(51) Int. Cl. G11B 7/00

(52) U.S. Cl. 369/13.05; 369/300; 369/13.15

(57) ABSTRACT

An optical device is provided including a conductive film having first and second surfaces, at least one aperture provided in the conductive film and extending from the first surface to the second surface, and a surface topography formed on at least one of the first and second surfaces, wherein said surface topography increases an intensity of light incident onto one of said first and second surfaces and transmitted through said aperture, wherein a region on which the surface topography is formed is larger than a region where the light is incident on the conductive film surface, and the aperture is formed on the region on which the surface topography is formed.

### BACKGROUND OF THE INVENTION

1. Field of the Invention

The present invention relates to an optical head and an optical recording/reproducing apparatus, and more particularly, to an optical head and an optical recording/reproducing apparatus accumulating information, of extremely high recording density and having high throughput and resolution.

2.Desrption of the Related Art

CD-ROMs (Compact Disk Read Only Memories) and DVDs (Digital Video Disks) have become more and more attractive data recording media because of their characteristic features such as high recording densities, compact designs, portabilities, and toughnesses, and in particular, because both the media and the recording/reproducing apparatus are becoming lower priced. In this optical recording medium, for recording and reproduction of long-term image data, a further improvement in the recording density has been desired. For recording and reproduction of long-term image data, an improvement in recording density has been desired.

For exceeding the present recording density in improvement of recording density, it is necessary to make the size of a light beam smaller at the time of writing or reading data. The size of a light spot at a focal point in a usual optical system, i.e., when a light-collecting lens is used, is determined mainly by the wavelength and the numerical aperture of the lens. In general, the size of the light spot can be made small by means of a short-wavelength light source and a lens having a high numerical aperture. In this method, however, there is a limit in spot size depending on the so-called diffraction limit, so that its size may be almost half of the wavelength of the light source.

Recently, attention has been focused on the technology of near-field optical technique which is never restricted in diffraction limit. For instance, in the vicinity of a micro aperture no longer than the wavelength, there is formed a minute light spot approximately equal in size to the aperture. By making use of this, the expectation is that the writing or reading of a minute bit by a minute light spot with no limitation to the wavelength of the light source would be realized. By making the aperture to approach the recording medium, if this is used, the writing or recoding of a minute pit can be realized by the minute optical spot which is not limited to the wavelength of a light source.

On the other hand, there were two problems to be solved in the optical head that utilizes the technology of near-field optical technique.

One problem is that light is hardly transmitted sufficiently through the aperture as the utilization efficiency of light is low. The power of light passing through an aperture formed in a metal film, where the size of the aperture (the aperture diameter d) is not more than the wavelength λ, decreases remarkably in proportion to the fourth power of (d/λ) as described in H. A. Bethe, “Theory of Diffraction by Small Hall”, Physical Review, vol. 66, pages 163-182 (1944). Therefore, the light transmission through the micro aperture has potential problems of a signal-to-noise ratio which is too low for the reading and a light intensity which is too low for the writing. As a result, a practical optical head using the technology of near-field optical technique has not been obtained until now.

For breaking down such a situation, there is a disclosure of optical transmission technology in which a metal film having a row of apertures having diameters less than the wavelength of light is used to extremely increase the transmission of light passing through the row of apertures. This is described in detail in the documents of: Ebbesen et al., “Extraordinary Optical Transmission Through Sub-Wavelength Hole Arrays”, Nature, vol. 391, pages 667-669 (Feb. 12, 1988); Ebbensen et al., U.S. Pat. No. 5,973,316 (JP-A-11-72607); Kim et al., U.S. Pat. No. 6,040,936 (JP-A-2000-111851); Ebbesen et al., U.S. patent application Ser. No. 09/208,116(U.S. Pat. No. 6,236,033)(JP-A-2000-171763) filed on Dec. 9, 1998; and Kim et al., U.S. patent application Ser. No. 09/435,132 filed on Nov. 5, 1999(U.S. Pat. No. 6,285,020).

According to this, the apertures are arranged in periodical arrangement or a periodical surface topography is formed on the conductive film associated with the aperture, so that the light intensity of light irradiated on the conductive film passing through one or more apertures formed in the conductive film having diameters less than wavelength extensively increases, compared with the case in which there is no periodical aperture and surface profile. According to an experimental verification, the growth rate may reach to 1,000 times higher. It is described that this increment can be occurred when the light incident on a conductive film interacts with a surface plasmon mode to be excited on the conductive film.

In JP-A-2001-291265, Sakaguchi et al. discloses a reading/writing head for an optical recording apparatus, where the head utilizes such a phenomenon and has extremely high transmitted light power density and resolution. There is described that a periodic surface topography formed on at least one surface of a metal film in this head allows the light incident on one surface of a metal film to interact with the surface plasmon mode on the metal film. As a result, the intensity of transmitted light passing through an aperture passing through the metal film is increased.

In FIG. 1, there is shown the structure of the reading/righting head disclosed in JP-A-2001-291265. This reading/writing head 500 comprises a waveguide 510 and a plasmon enhanced device 520. The waveguide 510 has an end face 512 positioned in close vicinity to the optical recording medium 550. The waveguide 510 has a tapered shape such that the area of the end face 512 of the reading/writing head 500 decreases. The distance z from the optical recording medium 550 is almost the same as the diameter of the aperture. The plasmon enhanced device 520 is provided in contact with the end face 512 of the waveguide 510, so that the transmission strength of light passing through the plasmon enhanced device 520 from the waveguide 510 increases. The plasmon enhanced device 520 has a metal film 522 preferably made of silver and provided with a through hole 530, so that the diameter of the through hole 530 determines the resolution of the device. The diameter d of the aperture 530 is the wavelength or less of light incident on the aperture and corresponds to the dimensions of a pit on the optical recording medium 550. A required intensity of transmitted light is determined by the power required for the writing of recording pit, for example the intensity of light should be sufficient for local melting when a medium 550 is a phase change optical recording medium. A periodic surface profile 540 is further provided on the metal film 522. An extremely high amount of transmitted light can be obtained by providing with such a periodic surface topography to realize a reading/writing head that allows an optical recording medium to be read and written with a size of a wavelength or less on. In this reading/writing head, it is possible to use any light source commercially available at present and thus it becomes possible to read and write with a minute size without depending on a light source having a wavelength shorter than this.

The problem of a low utilization efficiency of light in the optical head using the technology of near-field optical technique is solved by the above-described disclosure.

The second problem to be solved is one resulting mainly from the difficulty of the manufacture thereof. By increasing the utilization efficiency of light to the limit, there arose a need to bring the position of forming the micro aperture into correspondence with the position of collecting light from the light source. Means for solving the problem is not described in JP-A-2001-291265, because it is an unavoidable problem for the technology thereof.

JP-A-2001-74632 discloses a method, as shown in FIG. 2, for making a correct coincidence between the light-collecting position with a light-collecting part, such as a lens, in utilizing the technology of near-field optical technique.

Two light sources L and L′ having different wavelength characteristics, and a photo-resist film 650 having a photosensitivity to light from one of light source L′ but no photosensitivity to light from the other light source L are prepared on a base film 640, respectively. The base film 640 allows the transmission of a part of light from the light source L.

A base film 640 and a photo-resist film 650 are formed on a light-collecting part 631 that forms a micro aperture, and a light-shielding mask 660 having a micro aperture 661 is adjacent to a photo-resist film 650. On the other side of the light-shielding mask 660, which is opposite to the photo-resist film, there is provided a light sensor 680 that detects light leaked from a micro aperture 661 of the light-shielding mask 660 (FIG. 2(a)).

Light from the light source L is incident on a light-collecting part 631 to form an image on the photo-resist film 650. The position of the light-shielding mask 660 is adjusted such that the amount of light transmitted through the base film 640 and the photo-resist film 650 and observed by the light sensor 680 through the micro aperture 661 of light-shielding mask 660 becomes maximum.

Next, as shown in FIG. 2(b), the light source L′ is arranged at the position of the light sensor 680 instead of the light sensor. The photo-resist film 650 is exposed with light from the light source through the micro aperture 661 of the light-shielding mask and is then developed to form a micro aperture in this portion of the base film 640.

However, the above method has problems in that the formation of such a micro aperture requires great many steps and an assembled device becomes a complex product. Therefore, there is not realized a realistic method for simply and cost-effectively making a coincidence between the position on which the micro aperture is formed and the position which light is received from the light source.

### BRIEF SUMMARY OF THE INVENTION

An object of the present invention is to provide an optical device having high-throughput/high-resolution characteristics and realizing writing/recording operations on a minute recording pit, an optical module, and an optical head and an optical recording/reproducing apparatus using the optical device at a lower cost and a simple method. The present inventors have found a novel function in a structure having one or more apertures having diameters equal to a wavelength or less formed in a conductive film, and a periodic surface topography associated with the apertures which are not described and suggested in JP-A-2001-291265.

According to a first aspect of the present invention, the optical device comprises a conductive film having first and second surfaces, at least one aperture provided in the conductive film and extending from the first surface to the second surface, and a surface topography formed on at least one of the first and second surfaces, in which an intensity of light incident onto one of the surfaces and transmitted through said aperture is increased compared with one where the surface topography is absent, wherein a region on which the surface topography is formed is larger than a region where the light is incident on said conductive film surface and the aperture is formed on the region on which the surface topography is formed.

According to a second aspect of the present invention, the optical module comprises an optical device including a conductive film having first and second surfaces, at least one aperture provided in the conductive film and extending from the first surface to the second surface, and a surface topography formed on at least one of the first and second surfaces in which an intensity of light incident onto one of the surfaces and transmitted through the aperture is increased compared with one where the surface topography is absent, wherein the center of light flux of light incident on the conductive film is deviated from the center of the aperture.

The inventor has found that even though the aperture position in the conductive film is not always brought into a precise coincidence with the center of the incident light on the conductive film, it becomes possible to increase the intensity of the transmission of the light.

According to a third aspect of the present invention, the optical module comprises the optical device including a conductive film having first and second surfaces, at least one aperture provided in the conductive film and extending from the first surface to the second surface, a surface topography formed on at least one of the first and second surfaces in which an intensity of light incident onto one of the surfaces and transmitted through the aperture is increased compared with one where the surface topography is absent, and a means for varying an angle of a polarization surface of light incident on the optical device.

By defining appropriate positional relationships among the above surface topography, light flux, and aperture position, it can be increased the transmission of the intensity of the transmission light and it can be provided the optical module having a higher light-utilization efficiency at a lower cost.

### BRIEF DESCRIPTION OF DRAWINGS

FIG. 1 is a diagram showing the reading/writing head with a surface plasmon enhancement effect of the conventional example.

FIGS. 2(a) and (b) are diagrams showing the method for adjusting micro aperture in the near-field optical head of the conventional example.

FIG. 3 is a diagram showing one embodiment of an optical head of the present invention.

FIG. 4(a) is a cross-sectional view showing a positional relationship between the optical device and an optical spot in the optical head of the present invention.

FIG. 4(b) is a plane view showing a positional relationship between the optical device and the optical spot in the optical head of the present invention.

FIGS. 5(a) through (e) are diagrams illustrating the method for manufacturing the optical head of the present invention.

FIGS. 6(a) through (f) are diagrams illustrating the method for manufacturing the optical head of the present invention.

FIGS. 7(a) through (c) are diagrams illustrating the displacement of the optical axis between the incident light and the optical device in the method for manufacturing the optical head of the present invention.

FIG. 8 is a diagram showing the characteristics of displacement between the optical device and the light flux in the optical head.

FIG. 9 is a diagram showing the characteristics of displacement between the optical device and the light flux in the optical head of the present invention.

FIG. 10 is a diagram showing the characteristics of displacement between the optical device and the light flux in the optical head of the present invention.

FIG. 11 is a diagram showing the incident angle characteristics of light flux to the optical device in the optical head of the present invention.

FIG. 12 is a diagram illustrating the incident angle to the optical device in the optical head of the present invention.

FIGS. 13(a) through (d) are diagrams showing the incident angle characteristics of light flux to the optical device in the optical head of the present invention.

FIG. 14 is a diagram showing the configuration of the first embodiment of the optical recording/reproducing apparatus of the present invention.

FIG. 15 is a diagram showing the configuration of the second embodiment of the optical recording/reproducing apparatus of the present invention.

FIG. 16 is a diagram showing the configuration of the optical recording/reproducing apparatus of the present invention.

FIG. 17 is a diagram showing the configuration of the optical recording/reproducing apparatus of the present invention.

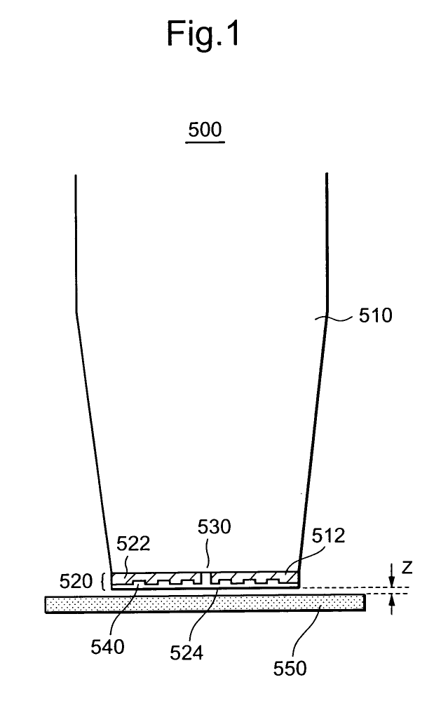

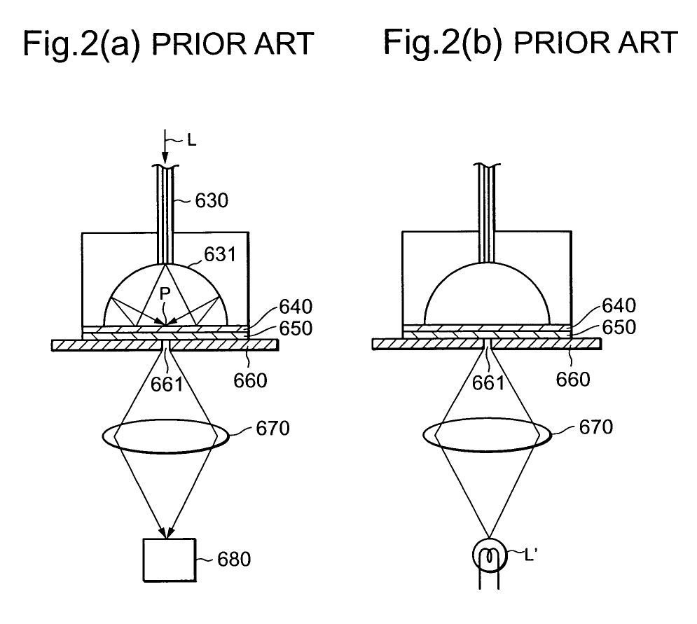

### DETAILED DESCRIPTION OF THE INVENTION

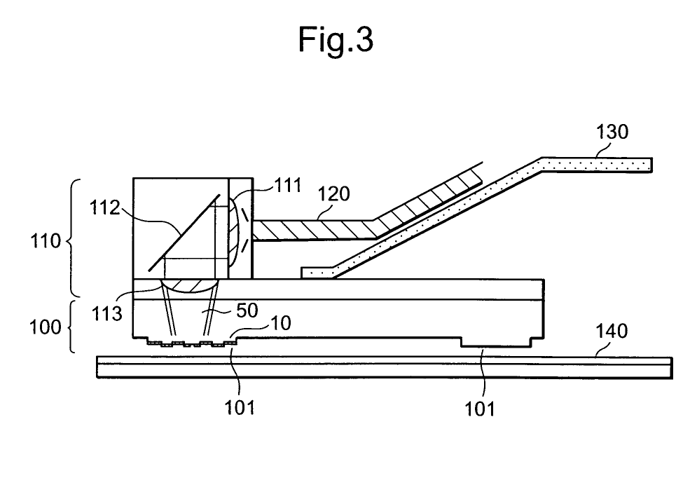

FIG. 3 is a first embodiment of the optical head of the present invention. The optical head shown in FIG. 3 comprises a slider 100, an optical device 10 formed on a surface facing to an optical recording medium 140 of the slider, a light-collecting optical system 110 for introducing light into an optical device, and an optical fiber 120 for transmitting light from a light source to the light-collecting optical system, and a suspension 130 for support thereof.

Here, with respect to the optical device 10, several preferable conditions for understanding the present invention will be described.

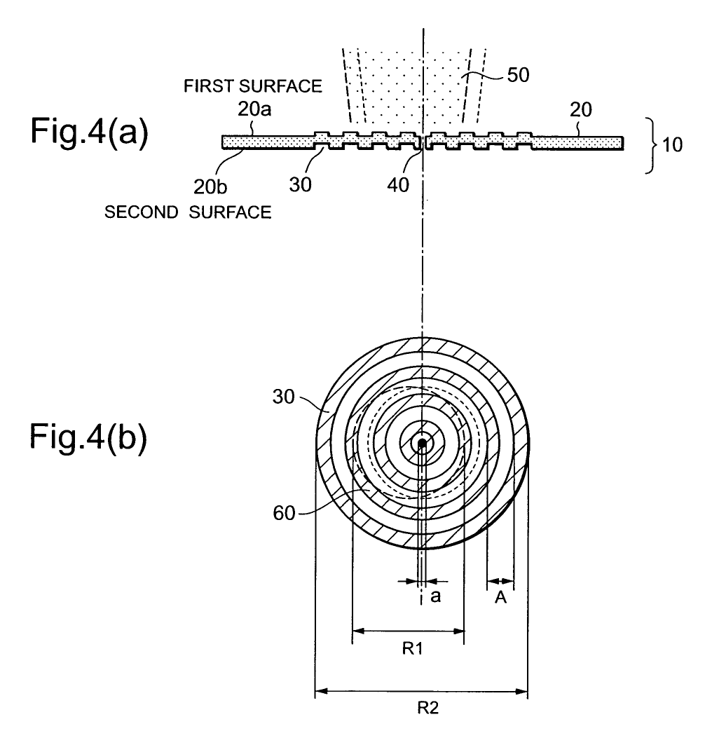

As shown in the cross sectional figure FIG. 4(a) and plan view FIG. 4(b), the optical device 10 comprises surface topography 30 in concentric circle form formed on both sides (20a and 20b) of a conductive film 20, and an aperture 40 passing through the conductive film 20 formed in the vicinity of the center thereof. The light flux 50 is irradiated on a first surface of the conductive film 20. The conductive film 20 is made of a metal or a doped semiconductor material, preferably made of aluminum, silver, gold, chrome, or the like. In FIG. 4(a), period-Λ topography is formed on both sides, a first surface 20a and a second surface 20b, of the conductive film.

Alternatively, a period-Λ surface topography may be only formed on one of these sides. Furthermore, the surface topography may be directly formed on the conductive film by a procedure such as an ion-milling, or may be formed by forming a surface topography on an arbitrary substrate at first and then forming a conductive film thereon to transfer the surface topography on the conductive film. As shown in FIG. 4, the surface topography comprises periodically raised or depressed patterns in which projections and depressions are formed around the aperture in concentric circle form. Alternatively, dimples and protrusions may be aligned in two-dimensional lattice, or grooves and ribs may be aligned in one-dimensional lattice or in two-dimensional lattice. In FIG. 4, the surface topography of the first surface and the second surface of the conductive film may be formed in phase or in out of phase (in a state of being shifted a half-period).

Furthermore, while FIG. 4 shows the case in which the shape of the aperture is a circle, the aperture can be provided with another shape such as an oval or a rectangle without departing from the scope of the present invention. It is preferable to have a diameter smaller than the wavelength of incident light for obtaining high-resolution characteristics equal to the wavelength or less. In the case when the aperture is in the shape of an oval or a rectangle, it is preferable that the length thereof in its short axial direction is smaller than the wavelength.

With respect to the position of the aperture, it is preferable to locate the aperture near the center of the surface topography. However, sufficient transmission of the light can be obtained even if the position of the aperture is deviated from the center of the surface topography. There is no large problem as long as its positional shift is Λ/4 or less. Describing this fact using the cross sectional view of the optical device shown in FIG. 4, it represents that there is no large loss of light transmission when at least a part of the aperture is formed in a recessed portion on the center of the surface topography.

Regarding the thickness of the conductive film, any optically opaque portions except the aperture should be at least larger than the penetration depth of incident light into the conductive film. However, when the thickness of the conductive film is longer than necessary, an aperture having a higher aspect ratio is necessary, and therefore, there is a preferable conductive film thickness due to difficulties in the manufacture of such an aperture.

Next, preferable dimensions in consideration of the surface plasmon mode with respect to the period Λ of the surface topography will be described. The following equation represents a condition for effectively exciting the surface plasmon mode in the case of light incident perpendicularly on the surface formed with the surface profile when the wavelength of incident light is λ and the period of the surface topography is Λ.

λ=Λ(εₘε_{d})^{1/2}/(εₘ+ε_{d})^{1/2} (1)

Here, εₘ represents the dielectric constant of the conductive film and ε_{d} represents the dielectric constant of a dielectric medium adjacent to the conductive film, respectively.

For instance, when silver was used as a conductive film and the period of the surface topography was 600 nm, a peak of light transmission strength was emerged at a wavelength of about 630 nm. In addition, when the period of the surface topography was 750 nm, a peak of light transmission strength was emerged at a wavelength of about 790 nm. Comparing the results with equation (1), it can be explained as a enhancement of light transmission strength by a surface plasmon mode of the surface on the air side of the silver. Consequently, by determining the period of the surface topography based on the wavelength of a light source, light transferred to an optical device can be suitably strengthened. Considering the realistic structure predicated on the actual production, it is conceivable that there may be a state in which both sides are not the same dielectric medium. For example, in the case that one of the surfaces of the conductive film is air and the other surface thereof is a substrate (base plate) that supports a conductive film. In this case, according to equation (1), the periodic profile suitable for each dielectric medium may be formed.

In addition, comparing with the case of no surface topography, a enhancement of light transmission can occur when any periodic structure is formed even though the period of the surface profile is not adjusted to the wavelength of the light source as described above. Therefore, it is not limited the size of the wavelength or the length of the period as described by using the equation.

Next, with respect to the material of the slider 100, it may be transparent to at least the wavelength of a light source to be used in its optical path. In addition, in the case of using a slider as a substrate for supporting a conductive film, i.e., as a base plate, it is preferable that the surface in contact with the conductive film is a surface which is as smooth as possible. In addition, for example, the slider 100 may be shaped as one having a bottom surface profile 101 being designed to face the recording medium 140 so as to keep its close distance to the recording medium 140 stable. This may be designed with reference to the form of an air-bearing surface of a floating head to be used in a hard disk drive or the like. The bottom surface profile is generally formed by a machine processing, or an etching process such as ion-milling. It is preferable to also consider the precision workability. Materials such as optical glass and quartz glass can be utilized.

Different from the flying head used in the hard disk drive or the like, there is a case in which a stable slider flying posture cannot be maintained by an asymmetric weight balance with an optical module attached on the upper portion of the slider, or the solidity or the like of an optical fiber additionally provided. In this case, a balancer that corrects a weight balance may be mounted on an appropriate portion of a slider/optical module complex. In addition, an optical fiber may be clamped (fixed) so as to not affect the flying operation.

A suspension 130 is provided in an appropriate position for supporting a complex comprised of the slider, optical device, and the optical module. For example, the suspension has at least one clamp portion, and the optical fiber is fixed by the clamp portion.

The light-collecting optical system 110 is desired to efficiently guide light from a light source to an optical device 10. As shown in FIG. 3, it may be comprised of an optical lens 111 for converting the light generated from an optical fiber 120 into collimated beam, an optical mirror 112 for polarizing the optical axis of the collimated beam at a right angle, and an optical lens 113 for collecting light on an optical device. As an optical lens, a flat micro lens having a predetermined gradient of the refractive index so as to be a hemispherical shape from one surface to the other surface may be used. Also, a fresnel zone plate that utilizes a diffraction phenomenon may be used. For instance, in the case of a refractive index gradient flat micro lens, it is possible to bond with, for example, a slider substrate on the stage of a bar (one-dimensional arrangement) or a wafer (two-dimensional arrangement) by forming multiple micro lenses on a sheet of an optical glass substrate with a selective ion-exchange method. Accordingly, a manufacturing method suitable for mass production can be constructed. Furthermore, an antireflective film may be provided on a part of or the whole of the mating surface of each member to take measure for increasing the utilization efficiency of light to the limit.

Regarding several preferable conditions to understand the present invention described above, it may be introduced to the optical head of the present invention in any conditions for stability and low cost.

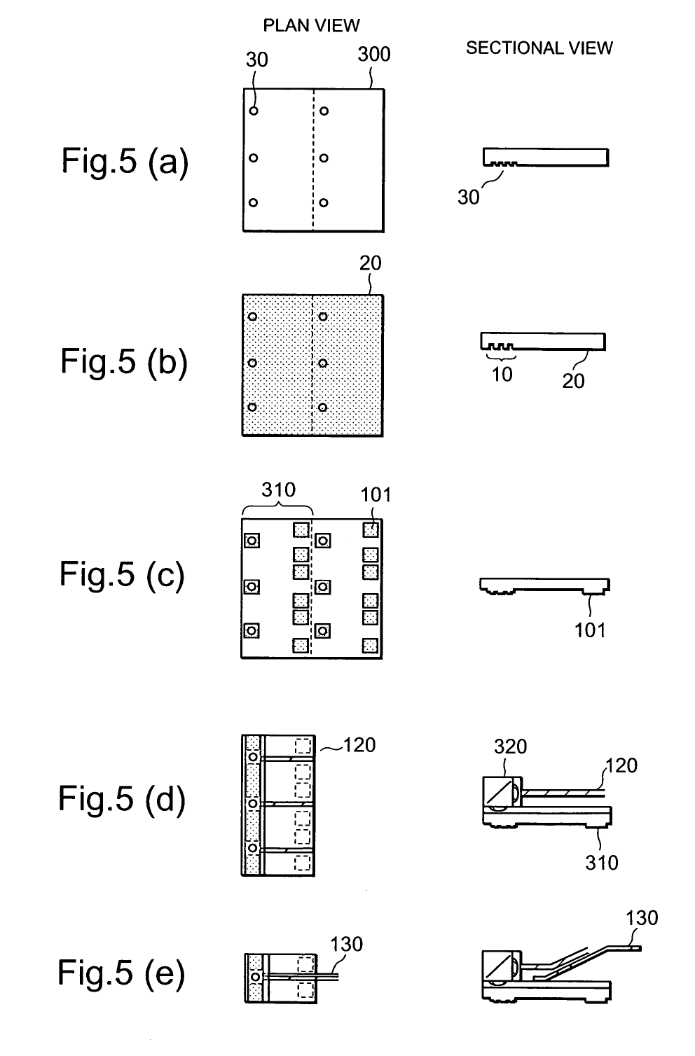

Next, a method for manufacturing the optical head of the present invention will be described with reference to FIG. 5. At first, a synthetic quartz base material was cut out into a wafer shape and the both sides thereof were ground to form flat surfaces, resulting in a slider base plate 300 having a thickness of 0.5 mm. On this, concentric-circle grooves having a depth of 200 nm and a period of 600 nm to be provided as a surface profile 30 were formed using a focused ion beam (FIB) processing (FIG. 5(a)). The width of the groove was adjusted so as to become a half of one period. In addition, the number of grooves was 10 (the outer diameter R2 of the grooves on the outermost side of the concentric circle grooves was about 12 μm). Then, a silver film of 300 nm in thickness to be provided as a conductive film 20 was formed thereon using a DC-spattering method. At this time, a surface topography having the same period as that of the surface topography previously formed on the base plate was reprinted on the surface (the air side) of the silver film. After that, an optical device 10 was obtained by forming a micro aperture having a diameter of 50 to 200 nm near the center of the surface profile by a FIB processing (FIG. 5(b)). It is preferable that the conditions of FIB processing may be suitably determined in consideration of the processing volume. For instance, at the time of forming the aperture, the diameter of ion beam aperture is minimized and a precise processing can be performed. At the time of forming the surface topography, a beam aperture to be used larger than one at the time of forming the aperture is used and the processing can be performed in favor of the processing throughput. Optical devices 10 are precisely arranged on the base plate at regular pitches. This pitch was determined in consideration of the outside dimension of the slider 100. That is, when the base plates are cut out at regular pitches, they can be utilized as sliders.

Next, using the technique of photolithography, predetermined portions including the optical device were covered with a resist and the periphery thereof was etched using an ion-milling to form a bottom surface profile 101 (FIG. 5(C)). It is cut out into the shape of a bar, and a slider array 310 in which pairs of the optical device 10 and the bottom surface profile 101 are arranged in a row is completed.

The light-collecting optical system 110 comprised of a complex of an optical lens and an optical mirror is prepared as a light-collecting optical system array 320 in which they are arranged in a row as with the slider array as previously described.

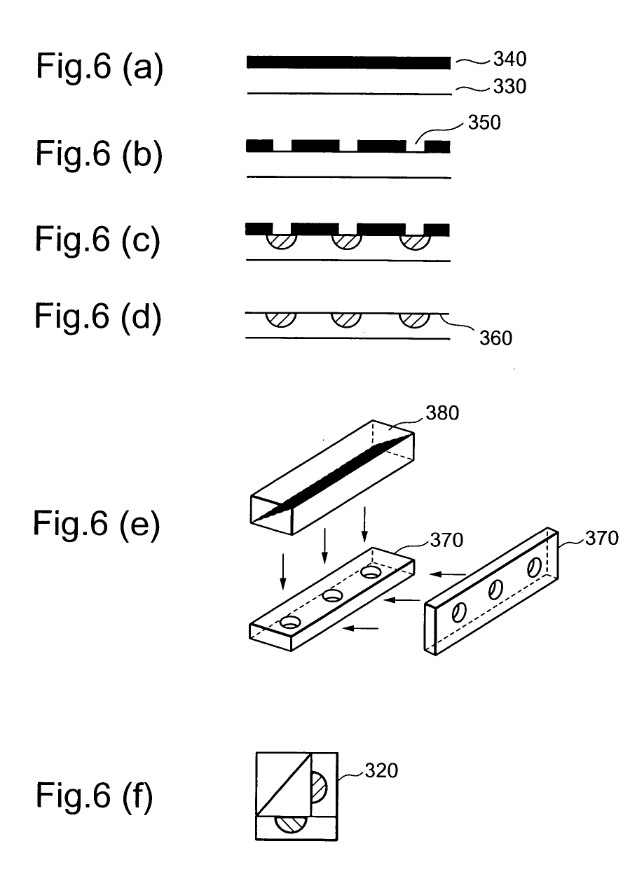

A method for manufacturing a light-collecting operating system array 320 will be briefly described with reference to FIG. 6. At first, a metal film 340 is formed on an optical glass base plate 330 (FIG. 6(a)). Circular apertures 350 are formed thereon by means of photolithography (FIG. 6(b)). Next, the base plate is dipped into molten salt to perform a selective ion exchange (FIG. 6(c)). After that, the metal film 340 is removed to form a flat micro lens 360 having a predetermined refractive index gradient in the form of a hemispheric shape in the thickness direction of the base plate (FIG. 6(d)). The circular apertures 350 may be of having predetermined pitches, more specifically the same pitches as those of the optical devices 10 being arranged in the slider array 310. It is cut out into the shape of a bar and is then provided as a micro lens array 370, and is combined with an optical mirror 380 (FIG. 6(e)) to complete a light-collecting optical system array 320 (FIG. 6(f)).

Next, the slider array 310 being cut into the bar shape, the light-collecting optical system array 320, and an optical fiber are positioned using a locating fixture, followed by applying an appropriate amount of an ultraviolet-curing resin on their adhesive portions and irradiating UV light for a predetermined time period for hardening and fixation (FIG. 5(d)). Finally, the bar-shaped slider/light-collecting optical array is cut into the form a predetermined slider shape and is bonded with a suspension 130 to provide an optical head (FIG. 5(e)).

In the fabricated optical head, a semiconductor laser of 630 nm in wavelength was used as a light source and the strength of light transmission from the aperture was investigated. The strength of light transmission from the aperture was measured at a position directly above the aperture.

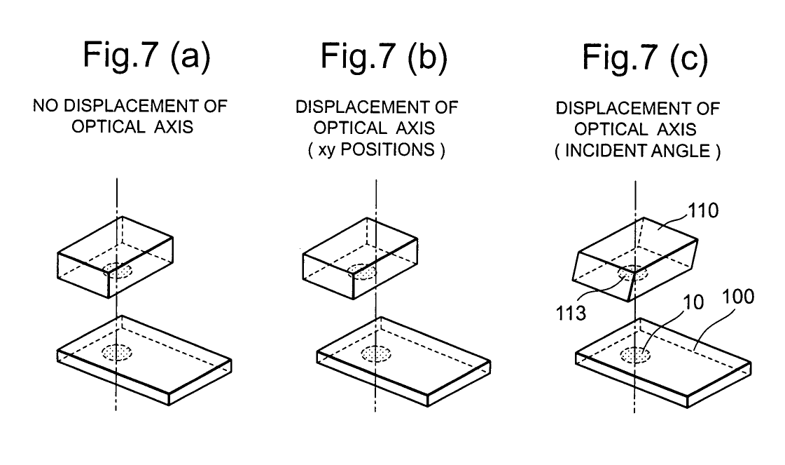

The fabricated optical heads were grouped into those having offset between a light flux and an optical device as shown in FIGS. 7(b) and (c), or those in which a light flux is incident on the optical device at an incident angle.

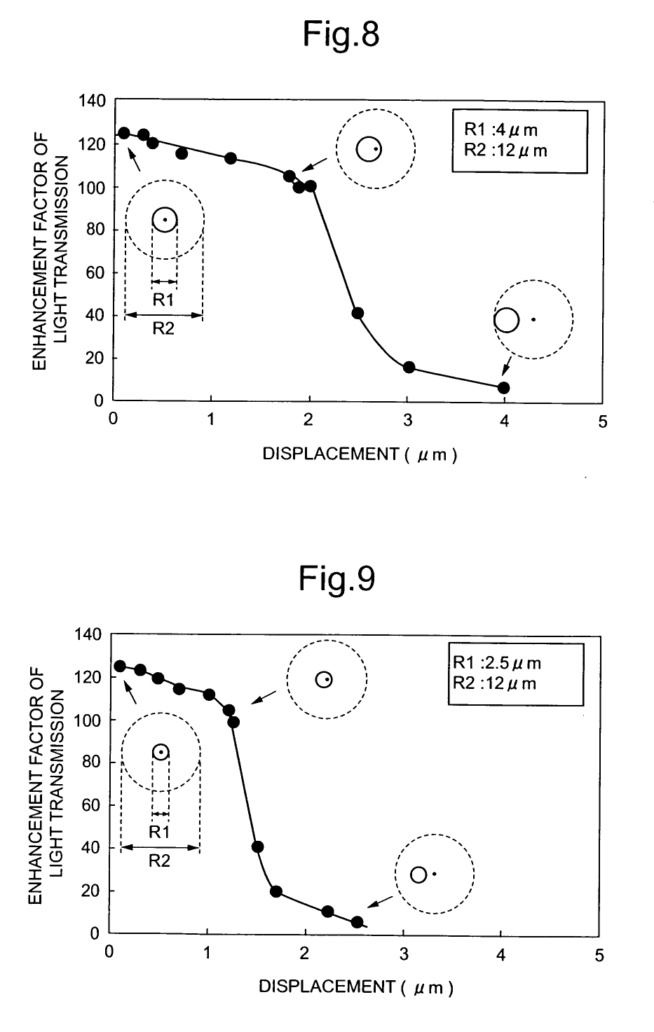

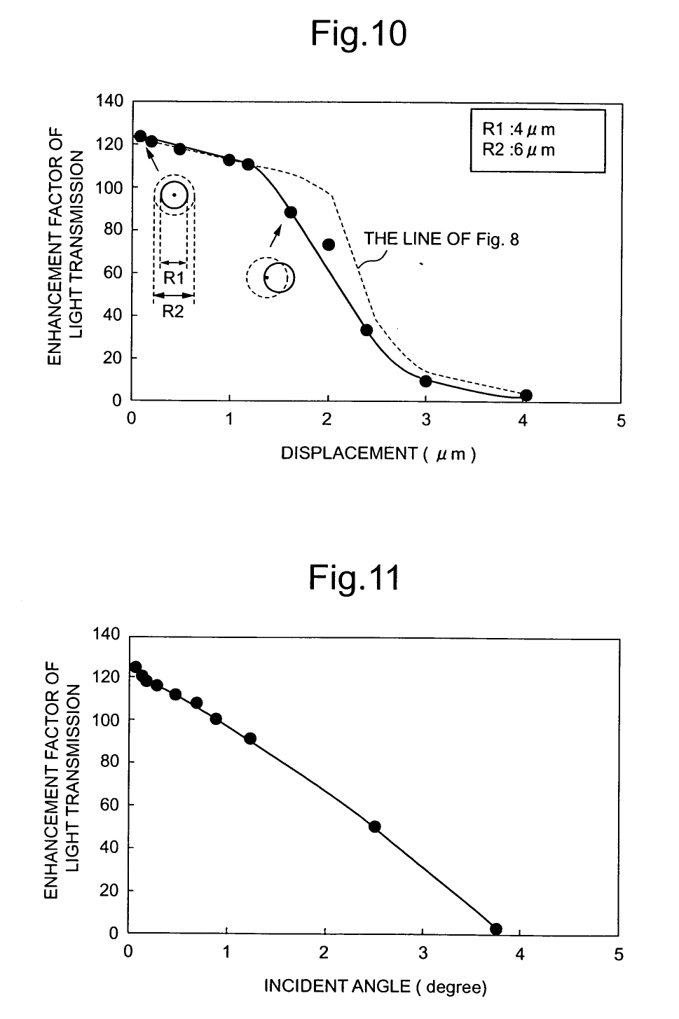

With respect to the fabricated optical head, the relationship between the displacement of the light flux/optical device (aperture) and the amplification factor of light-transmitting efficiency is shown in FIG. 8. For the fabricated optical head, the focusing diameter R1 of the light spot on the optical device position was about 4 μm. Here, the amplification rate of the optical transmission was calculated using the following equation.

The enhancement factor of light transmission=(the intensity of light transmission from the aperture of the sample having a periodic surface topography)/(the intensity of light transmission from the aperture of the sample having no periodic surface topography) (2)

In the figure, R1 denotes the diameter of a light flux incident on the optical device, R2 denotes the outer diameter of an outermost groove of a periodic structure formed in the shape of concentric circles centered on the aperture. Furthermore, in the same figure, a portion (dotted-line circle) having the periodic structure, an aperture (dots), and a light flux (solid-line circle) are represented and their positional relationships are schematically represented.

As shown in FIG. 8, even though the enhancement factor of light transmission gradually decreases as the center of the light flux is shifted from the position of the aperture, the light enhancement factor is over 100 or more when the amount of displacement is a half or less of the focusing diameter R1 (4 μm) of the light flux.

Therefore, the optical device of the present invention is able to realize an enhanced light transmission even though the center of incident light flux and the position of the aperture are not perfectly coincident with each other. In addition, a remarkable increase in optical transmission can be obtained by adjusting the positional relationship among the surface topography, the light flux, and the aperture within a predetermined range.

With respect to another fabricated optical head, the relationship between the displacement of the light flux/optical device (aperture) and the enhancement factor of the light-transmission is shown in FIG. 9. In the fabricated optical head, the focusing diameter R1 of the light flux at the position of the optical device was about 2.5 μm. By the way, the shape and period of surface profile and the wavelength of incident light were similar to those values of the optical device used in the above characteristic evaluation of FIG. 8.

As shown in FIG. 9, even though the enhancement factor of light transmission gradually decreases as the center of the light flux is shifted from the position of the aperture, the enhancement factor is over 100 or more when the amount of displacement is a half or less of the focusing diameter R1 (2.5 μm) of the light flux.

Consequently, without depending on the focusing diameter R1 of the light flux, a practically sufficient increase in the enhancement factor was observed when the displacement is almost half of the focusing diameter R1, in other words the aperture was included in the light flux.

With respect to another fabricated optical head, the relationship between the displacement of the light flux/optical device (aperture) and the enhancement factor of light-transmission is shown in FIG. 10. For the fabricated optical head, the focusing diameter R1 of the light spot on the optical device position was about 4 μm. In addition, the number of grooves is five (the outer diameter R2 of the surface profile was about 6 μm). By the way, the shape and period of surface topography and the wavelength of incident light were similar to those values of the optical device used in the above characteristic evaluation of FIG. 8.

As shown in FIG. 10, the enhancement factor of light transmission gradually decreases as the center of the light flux is shifted from the position of the aperture. Furthermore, comparing with the case shown in FIG. 8 described above, which has the same focusing diameter R1 of the light flux, a remarkable decrease in the enhancement factor of the light transmission was observed especially at a position with a displacement of more than 1.2 μm. This may be caused by a decrease in the efficiency of utilizing light in this region as a part of the light flux becomes arranged so as to be irradiated to the outside of the surface topography. That is, for preventing a decrease in the enhancement factor of the light transmission, there is a need to form a surface topography (on a region larger than the area of the light flux) so as to include at least the light flux at a light-collecting position of light incident on the optical device.

From the data representing the relationship between the displacements of three light fluxes/optical devices (aperture) shown in FIGS. 8 to 10 described above, it means that the displacement of the center of light flux from the micro aperture can be allowed up to almost the radius of the light flux when the light flux is in being existence within the outer diameter of the surface profile of the optical device. This is a characteristic feature which cannot be obtained by the optical device that utilized a near-field optical technology as described in the prior art technology.

In the examples shown in FIGS. 8 to 10 described above, the examples show the case of making the surface topography into the shape of a concentric circular ring. The same effects can be obtained by a periodic structure having another structure. For instance, in the case of making the aperture into the shape in which circular protrusions are formed in mesh around the aperture or in the case of periodically forming evenly spaced grooves in the vertical direction, the similar tendency (an excellent enhancement factor is obtained when the displacement is a half or less of the diameter of light flux, a decrease in the amplification rate is prevented by the formation of a periodic structure so as to include the light flux at the light-collecting position of light incident on the optical device, and so on) was obtained.

For example, in the case of meshed surface profile, it was performed under the same conditions as those of the configuration of FIG. 8 except that each space of protrusions (vertical or lateral space) was 600 nm and the diameter of the protrusion was 300 nm. In the case of periodically forming grooves in the vertical direction, it was performed under the same conditions as those of the configuration of FIG. 9 except that the length of a groove in the vertical direction was 10 μm, the width of the groove was 300 nm, and the space of grooves was 600 nm.

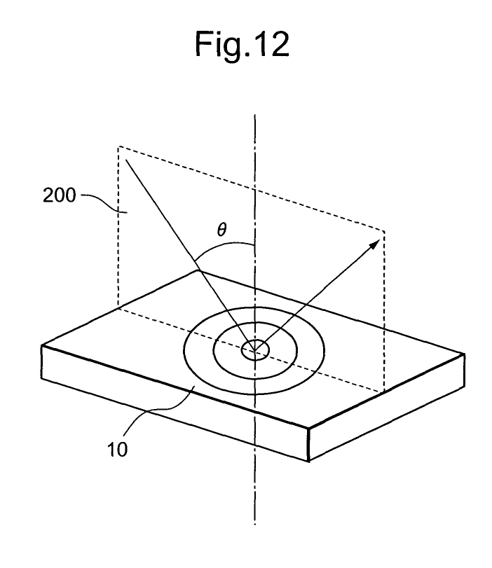

In FIG. 11, there is shown the relationship between the incident light angle and the enhancement factor of light transmission with respect to an optical head that uses the same optical device as one used for the characteristic evaluation in FIG. 8 described above. By the way, the wavelength of the incident light is similar to that of the optical device used in the characteristic evaluation in FIG. 8 described above. As shown in FIG. 12, the incident light angle θ is defined by the angle of an incident optical axis with respect to the direction of the normal to the optical device within the incident surface of light. In the actual optical head, it is determined by the actual optical head, an angle between the slider and the mating surface of the optical module, a mating angle of the optical mirror/optical lens that constitute an optical module, a mating angle of an optical fiber, or the like can be determined.

As shown in FIG. 11, when the incident angle is smaller than 2 degrees even though the enhancement factor of the optical transmission gradually decreases as the incident light increases, a remarkable increase in the light transmission by 100 times or more is observed. A remarkable increase in light transmission by 50 times or more is still observed when the incident angle is 5 degrees. Therefore, by defining the range of incident light angle within suitable values, a remarkable increase in light transmission can be obtained without an influence of the shift of wavelength λ at which the surface plasmon mode is effectively excited.

Consequently, the optical head of the present invention is able to realize an optical head having a practically sufficient optical transmission by defining the assembly precision of each member, i.e., the positional relationship between an optical device and the optical axis of light incident thereon into a most preferable state.

Furthermore, in Table 1, with respect to the fabricated optical device, there is shown the results of investigating the enhancement factor of light-transmission while adjusting the angle in the polarization direction of incident linear polarization. In this example, for arbitrarily adjusting the angle in the polarization direction, an influence of difference in the polarization direction of incident light was investigated by inserting a faraday element between the light source and the optical fiber and adjusting a magnetic field to be applied on the faraday element. Furthermore, in the fabricated optical head, the focusing diameter R1 of a light spot at the position of the optical device was about 4 μm. In addition, the number of grooves was 10 (the outer diameter R2 of the surface topography was about 12 μm). By the way, the shape and period of surface topography and the wavelength of incident light were similar to those values of the optical device used in the above characteristic evaluation of FIG. 8.

TABLE 1

| | Enhancement | |
|---|---|---|
| | factor of light transmission | Enhancement factor of light |
| Displacement | before adjusting | transmission after adjusting |
| (μm) | polarization direction | polarization direction |
| 0.4 | 120 | 122 |
| 1.2 | 113 | 117 |
| 1.8 | 105 | 112 |

In Table 1, there is shown a change in enhancement factor of the light transmission when the displacement is changed to 0.4 μm, 1.2 μm, or 1.8 μm. In the table, the enhancement factor of light transmission before adjusting polarization surface and the enhancement factor in a state of being maximum by the adjustment are indicated. The polarization may be a linear polarization, and brings a direction of electric field oscillation of the linear polarization into coincidence with a direction connecting between the center of the light flux and the center of the aperture.

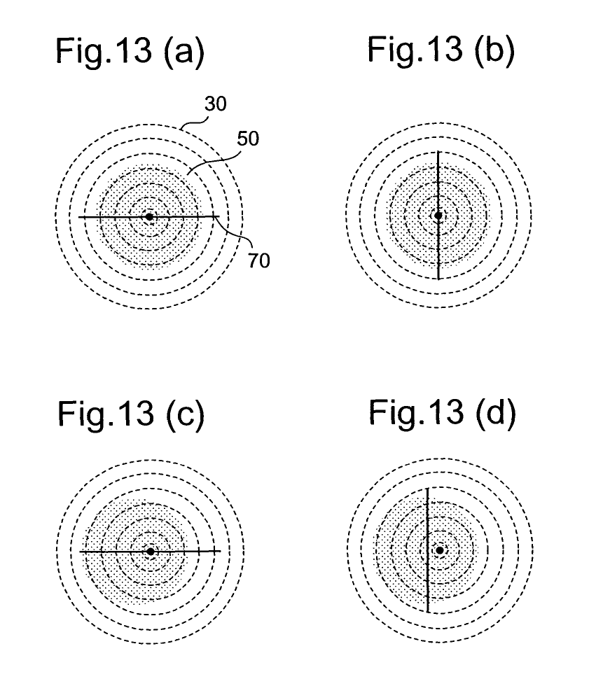

As shown in Table 1, by turning the polarization direction by adjusting a magnetic field applied on the faraday element, an increase in enhancement factor of the light-transmission was observed. This result can be speculated as follows. In the case that the surface profile and the center of the light flux are completely or almost coincident with each other (FIGS. 13(a) and (b)), there is little effect of or a little effect of adjusting the polarization direction (indicating the oscillation direction 70 of the electric filed in FIG. 13). This is because, when the surface profile is shaped like concentric circles, the surface topography is always on the same arrangement with respect to the polarization direction irrespective of the polarization direction. On the other hand, when the displacement between the surface profile and the center of light flux exists(FIGS. 13(c) and (d)), it is supposed that there is a favorable polarization direction. That is, in the case of FIG. 13(C) comparing with FIG. 13(d), it is considered that the surface plasmon mode can be effectively excited. In other words, when the displacement between the surface profile and the center of light flux exists, the enhancement factor of the light transmission can be increased by incorporating means for varying the polarization direction. By the way, there is possibilities that other phenomenon such as the diffraction caused by the periodic structure or interference may contribute to the present phenomenon.

An optical element capable of varying the angle of the polarization surface of incident light is not always necessary in an optical system of the present invention. For instance, a wavelength plate, a faraday element, or the like can be used. In addition, these optical elements capable of varying the angle of the polarization may be located on an optical path between a light source and the optical device.

In the present invention in the preferable manufacturing process, for example, a method for realizing a high positioning accuracy shown may form a hollow, a groove, a projection, or a protruded portion provided on each member for positioning on a predetermined position and combine each of them together with one of others. This is the most simple and cost effective method.

Alternatively, the positioning of each member can be performed more precisely by introducing light into the actual member. For instance, in a state shown in FIG. 5(d), light is introduced into one or plural optical modules and output light from the optical device is measured while performing the positioning. In this case, output light from the minor aperture may be monitored, or alternatively windows to be used as positioning parts may be formed at positions of optical devices in advance to permit the step of positioning at this portion.

In addition to the embodiment described above, the same effects can be obtained by other analogous structures as far as it is possible to realize the positioning accuracy indicated by the present invention. For instance, in the base plate of a slider, a structure may be one in which a light-focusing micro lens is formed on the side opposite to a surface on which an optical device is formed and the optical device and the light-collecting lens are integrally formed. In this case, there is a need of considering the degree of parallelization between the opposite surfaces of the slider base plate with respect to incident light.

Furthermore, the manufacturing method of the present invention is not limited to the above embodiment, so that other manufacturing methods may be allowable as far as a similar structure can be realized.

By the way, at the time of fabricating the actual device, an error (displacement) of the optical axis may be mainly generated, for example, at the time of bonding between the optical fiber and the light-collecting optical system or at the time of bonding between the light-collecting optical system and the optical head. In the present invention, therefore, by adjusting an error to be generated in this portion, i.e., as described above, a device capable of a sufficient increase in light transmission can be provided by adjusting the displacement so as to be a half or less of the light flux.

As described above, the present invention has an effect of generating practically sufficient light transmission by defining an assembling accuracy of each member, i.e., the positional relationship between the optical device and the optical axis of light incident thereon in the optical head having an aperture corresponding to a wavelength or less and by a periodic surface topography.

Next, an embodiment of an optical recording/reproducing apparatus using the optical head of the present invention will be described.

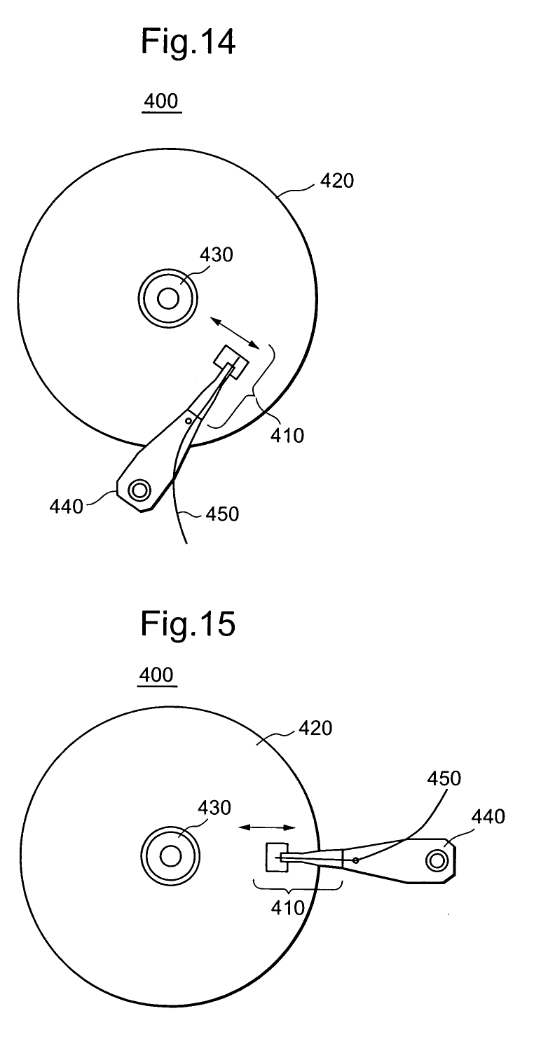

In FIG. 14, an optical recording/reproducing apparatus 400 is shown. The optical recording/reproducing apparatus 400 comprises an optical recording medium 420 attached on the center of a rotary shaft 430 in the inside of a housing and an optical head 410 fixed on an arm 440. A voice coil motor (not shown) imparts a rotary motion on the arm. In addition, an optical recording medium is rotated at a predetermined number of rotations as a spindle motor to be drive-controlled by a control circuit. This rotary operation allows a slider portion located at the tip of an optical head 410 to allow a floatation-running on an optical recording medium, so that the optical device formed on the surface of the slider facing to the medium and the recording medium are stably kept in a state of being adjacent 100 nm or less. Furthermore, particularly, in the optical head of the present invention, it is possible to record with an extremely small light flux compared with the conventional one, so that a high-density information recording can be realized, which is not found in the prior art.

FIG. 15 shows another embodiment of an optical recording/reproducing apparatus using an optical head of the present invention. The optical recording apparatus 400 comprises an optical recording medium 420 attached on the center of a rotary shaft 430 in the inside of a housing and an optical head 410 fixed on an arm 440. The arm is operated linearly by a voice coil motor (not shown). In addition, an optical recording medium is rotated at a predetermined number of rotations as a spindle motor to be drive-controlled by a control circuit. This rotary operation allows a slider portion located at the tip of an optical head 410 to allow a floatation-running on an optical recording medium, so that the optical device formed on the surface of the slider facing to the medium and the recording medium are stably kept in a state of being adjacent 100 nm or less. Furthermore, particularly, in the optical head of the present invention, it is possible to record with an extremely small light flux compared with the conventional one, so that a high-density information recording can be realized, which is not found in the prior art.

For reproducing the information recorded on the optical recording medium 420, a phase change medium is used as an optical recording medium. In the optical head of FIG. 3, furthermore, light reflected from the medium can be read out by forming a photo detector on the surface of the optical device 10 on the optical recording medium side.

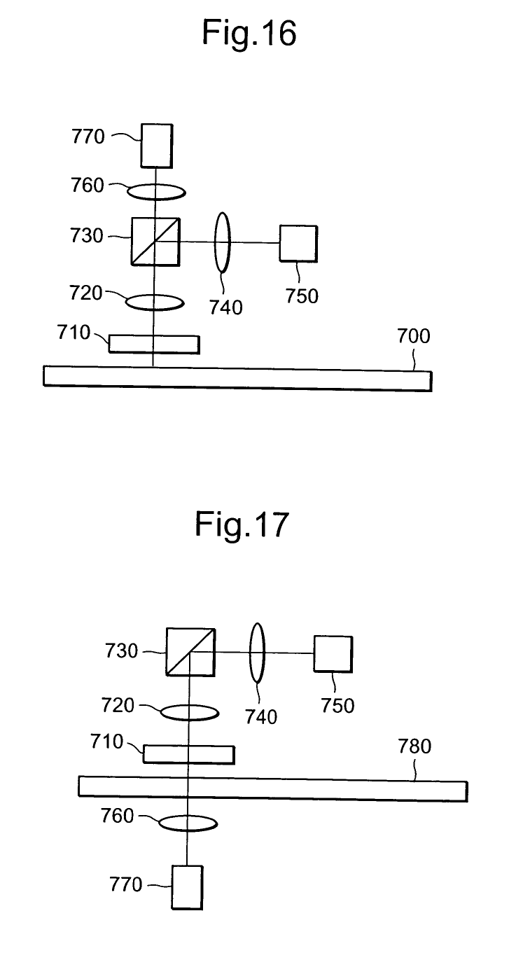

FIG. 16 shows the optical recording/reproducing apparatus using an optical head of the present invention, which reproduces information according to light reflected from the optical recording medium. In FIG. 16, light from a light source 750 is collected by a optical lens 740. The angle of the light is changed by the half mirror 730, and an optical lens 720 collects the light to the optical device 710. The optical device, in turn, directs the light toward the optical recording medium 700. The light reflected from the optical recording medium 700 is collected by an optical lens 760 through the half mirror 730, and detected by a photodetector 770. The photodetector may be arranged on the side of the optical device facing to the optical recording medium, as a more simple structure.

FIG. 17 shows the optical recording/reproducing apparatus using an optical head of the present invention, which reproduces information according to light passing through the optical recording medium. In FIG. 17, light from a light source 750 is collected by an optical lens 740. The angle of the light is changed by the half mirror 730, and an optical lens 720 collects and directs the light toward the optical device 710. The light passing through the optical recording medium 780 is collected by an optical lens 760, and detected by an optical device 770. The optical recording medium 780 for producing information using the passing light may be required to adjust the structure so that S/N of the transmission light can be obtained efficiently.

In addition, a magneto-optic recording medium may be used as an optical recording medium, the recording is performed optically, and a leakage magnetic flux from the medium can be magnetically reproduced by the head using a magneto-resistance effect.

In the above description of the embodiment, even though the cases to be applied on the optical head have been described in detail, the optical device of the present invention is not limited to such an application. For instance, it can be applied on nanophotonic devices and systems including the above light-collecting instrument, microscopic probe, and so on. In particular, the optical device of the present invention has a high resolution performance attained by a micro aperture having a diameter corresponding to a wavelength or less and the wavelength selectivity due to a periodic surface topography, therefore, it can be used as a user friendly nanophotonic element.

What is claimed is:

1. An optical device comprising:
a conductive film having first and second surfaces;
at least one aperture provided in said conductive film and extending from said first surface to said second surface; and
a surface topography formed on at least one of said first and second surfaces, wherein said surface topography increases an intensity of light incident onto one of said first and second surfaces and transmitted through said aperture;
wherein a region on which said surface topography is formed is larger than a region where said light is incident on said conductive film surface, and
wherein said aperture is formed on said region on which said surface topography is formed.

2. The optical device according to claim 1,
wherein said surface topography is formed in the shape of concentric circles.

3. The optical device according to claim 1,
wherein the diameter of said aperture is smaller than the wavelength of said incident light.

4. An optical module comprising:
an optical device including a conductive film having first and second surfaces, at least one aperture provided in said conductive film and extending from said first surface to said second surface, and a surface topography formed on at least one of said first and second surfaces, wherein said surface topography increases an intensity of light incident onto one of said first and second surfaces and transmitted through said aperture;
wherein the center of light flux of light incident on said conductive film is deviated from the center of said aperture.

5. The optical module comprising optical device according to claim 4,
wherein a displacement between the center of light flux of light incident on said conductive film and the center of said aperture is ½ or less of the diameter of said light flux.

6. The optical module according to claim 4,
wherein the light flux of light incident on said optical device is formed so as to include at least said aperture.

7. The optical module according to claim 4,
wherein a displacement between the center of said aperture and the center of said surface topography is ¼ or less of a period of said surface topography.

8. An optical module comprising:
an optical device including a conductive film having first and second surfaces, at least one aperture provided in said conductive film and extending from said first surface to said second surface, and a surface topography formed on at least one of said first and second surfaces, wherein said surface topography increases an intensity of light incident onto one of said a first and second surfaces and transmitted through said aperture; and
a means for varying an angle of a polarization surface of light incident on said optical device.

9. The optical module according to claim 8,
wherein said angle is adjusted by varying an angle that brings a direction of said polarization into coincidence with a direction connecting between the center of said light flux and the center of said aperture.

10. The optical module according to claim 8,
wherein the center of light flux of light incident on said conductive film is deviated from the center of said aperture.

11. The optical module according to claim 10,
wherein a displacement between the center of light flux of light incident on said conductive film and the center of said aperture is ½ or less of the diameter of said light flux.

12. The optical module according to claim 10,
wherein a displacement between the center of said aperture and the center of said surface topography is ¼ or less of a period of said surface topography.

13. An optical head for recording and/or reproducing information on an optical recording medium comprising:
a slider adjacent and facing to said optical recording medium;
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture;
wherein the center of light flux of light incident on said conductive film is deviated from the center of said aperture.

14. The optical head according to claim 13,
wherein a displacement between the center of light flux of light incident on said conductive film and the center of said aperture is ½ or less of the diameter of said light flux.

15. The optical head according to claim 13,
wherein the light flux of light incident on said optical device is formed so as to include at least said aperture.

16. The optical head according to claim 13,
wherein said displacement between the center of said aperture and the center of said surface topography is ¼ or less of a period of said surface topography.

17. The optical head according to claim 13,
further comprising an optical fiber for transmitting light from a light source; and
a light-collecting optical system for collecting light emitted from a optical fiber to said optical device.

18. The optical head according to claim 17,
wherein said light-collecting optical system comprises a lens for collimating light outputted from said optical fiber and a light-collecting lens for directing said collimated light to said optical device.

19. An optical head for recording and/or reproducing information on an optical recording medium comprising:
a slider adjacent and facing to said optical recording medium;
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture; and
a means for varying an angle of a polarization surface of light incident on said optical device.

20. The optical head according to claim 19,
wherein the center of light flux of light incident on said conductive film is deviated from the center of said aperture.

21. The optical head according to claim 19,
wherein a displacement between the center of light flux of light incident on said conductive film and the center of said aperture is ½ or less of the diameter of said light flux.

22. The optical head according to claim 19,
wherein a displacement between the center of said aperture and the center of said surface topography is ¼ or less of a period of said surface topography.

23. The optical head according to claim 19,
wherein said angle is adjusted by varying an angle that brings a direction of said polarization into coincidence with a direction connecting between the center of said light flux and the center of said aperture.

24. An optical recording/reproducing apparatus for recording/reproducing information on an optical recording medium comprising:
an optical head according to claim 13;
wherein said optical head reproduces information recorded on said optical recording medium according to light reflected from said optical recording medium.

25. The optical recording/reproducing apparatus for recording/reproducing information on an optical recording medium comprising:
an optical head according to claim 19;
wherein said optical head reproduces information recorded on said optical recording medium according to light reflected from said optical recording medium.

26. The optical recording/reproducing apparatus comprising:
an optical recording medium recording information using light from a light source;
a recording optical head comprising:
a slider adjacent and facing to said optical recording medium;
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture,
wherein the center of light flux of light incident on said conductive film is deviated from the center of said aperture; and
a reproducing optical head for receiving and reproducing transmitted light passing through said optical recording medium.

27. The optical recording/reproducing apparatus comprising:
an optical recording medium recording information using light from a light source;
a recording optical head comprising:
a slider adjacent and facing to said optical recording medium,
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture,
a means for varying an angle of a polarization surface of light incident on said optical device; and
a reproducing optical head for receiving and reproducing transmitted light passing through said optical recording medium.

28. An optical recording/reproducing apparatus for recording/reproducing information on a magneto-optical recording medium comprising:
a recording optical head comprising:
a slider adjacent and facing to said optical recording medium,
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture,
wherein the center of light flux of light incident on said conductive film is deviated from the center of said aperture; and
a reproducing head detecting detects a leaked magnetic flux of said magneto-optical recording medium according to a magneto-resistance effect.

29. An optical recording/reproducing apparatus for recording/reproducing information on a magneto-optical recording medium comprising:
a recording optical head comprising:
a slider adjacent and facing to said optical recording medium,
an optical device formed on a surface of said slider facing to said optical recording medium, including a conductive film having first and second surfaces, at least one aperture provided in said conductive film and extending from said first surface to said second surface, a surface topography formed on at least one of said first and second surfaces, wherein said surface topography increases an intensity of light incident onto one of said surfaces and transmitted through said aperture,
a means for varying an angle of a polarization surface of light incident on said optical device; and
a reproducing head detecting detects a leaked magnetic flux of said magneto-optical recording medium according to a magneto-resistance effect.
